(19) United States
(12) Patent Application Publication
(10) Pub. No.: US 2026/0013410 A1
(43) Pub. Date: Jan. 15, 2026

(54) HITCH ASSEMBLY OF AN AGRICULTURAL IMPLEMENT SYSTEM

(71) Applicant: CNH Industrial America LLC, Racine, WI (US)

(72) Inventors: Timothy R. Blunier, Danvers, IL (US); Brice Magarity, Deer Creek, IL (US)

(21) Appl. No.: 18/768,847

(22) Filed: Jul. 10, 2024

(51) Int. Cl. A01B 59/00

(52) U.S. Cl. CPC A01B 59/002

(57) ABSTRACT

An agricultural implement system includes a hitch assembly having a hitch configured to couple the agricultural implement system to a work vehicle. The hitch assembly also includes an actuator configured to control the hitch. Furthermore, the agricultural implement system includes a control assembly communicatively coupled to the actuator. The control assembly includes a memory configured to store instructions and one or more processors. In addition, the control assembly is configured to control the actuator to operate the hitch assembly in a floating mode while the agricultural implement system is in a working position and to operate in a rigid mode while the agricultural implement system is in a non-working position.

### BACKGROUND

The present disclosure relates generally to a hitch assembly of an agricultural implement system.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A wide range of agricultural implements have been developed and are presently in use for cultivating, tilling, planting, spraying, harvesting, or the like. An agricultural implement, for example, is commonly coupled to and towed by a work vehicle, such as a tractor. The agricultural implement may be operated in an agricultural field and transported between various locations, including the agricultural field. For example, an agricultural implement may till soil as the work vehicle tows the agricultural implement through a field. In addition, the agricultural implement may be transported on a road while coupled to the work vehicle.

### BRIEF DESCRIPTION

This summary is provided to introduce a selection of concepts that are further described below in the detailed description. This summary is not intended to identify key or essential features of the claimed subject matter, nor is it intended to be used as an aid in limiting the scope of the claimed subject matter.

In certain embodiments, an agricultural implement system includes a hitch assembly having a hitch configured to couple the agricultural implement system to a work vehicle. The hitch assembly also includes an actuator configured to control the hitch. Furthermore, the agricultural implement system includes a control assembly communicatively coupled to the actuator. The control assembly includes a memory configured to store instructions and one or more processors. In addition, the control assembly is configured to control the actuator to operate the hitch assembly in a floating mode while the agricultural implement system is in a working position and to operate in a rigid mode while the agricultural implement system is in a non-working position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having an agricultural implement system, in accordance with an aspect of the present disclosure;

FIG. 2 is a block diagram of an embodiment of a control system that may be employed within the agricultural system of FIG. 1, in accordance with an aspect of the present disclosure;

FIG. 3 is a perspective view of the agricultural implement system of FIG. 1, in accordance with an aspect of the present disclosure;

FIG. 4 is a side view of a portion of the agricultural implement system of FIG. 1 in a working position, in accordance with an aspect of the present disclosure;

FIG. 5 is a schematic diagram of an embodiment of a hydraulic circuit that may be employed within the agricultural implement system of FIG. 1, in accordance with an aspect of the present disclosure; and

FIG. 6 is a schematic diagram of an embodiment of a hydraulic circuit that may be employed within the agricultural implement system of FIG. 1, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming may include cultivating, tilling, harrowing, planting, spraying, mowing, spreading, and/or harvesting one or more agricultural fields. An agricultural system may be configured to prepare soil to produce agricultural products (e.g., food crops, feed crops, fiber crops, oil crops, and the like). The agricultural system may include a work vehicle (e.g., tractor) and an agricultural implement system. The work vehicle is coupled to the agricultural implement system, and the work vehicle may tow the agricultural implement system through agricultural fields and between the agricultural fields. Coupling the work vehicle to the agricultural implement system may include coupling a hitch of the work vehicle to a hitch assembly (e.g., including a drawbar hitch, a t-hitch, a three-point hitch, a fully mounted hitch, a semi-mounted hitch, a fast hitch, or the like) of the agricultural implement system. The agricultural implement system may be operated in various positions (e.g., configurations). The various positions may include a working position (e.g., operational position) and a non-working position (e.g., transport position, storage position, and the like). Certain hitch assemblies are rigid (e.g., the hitch does not rotate relative to a main frame of the implement), and other hitch assemblies float (e.g., the hitch is free to rotate relative to the main frame of the implement).

For a rigid hitch assembly, the hitch may not rotate relative to the main frame of the implement, thereby establishing a constant angle between the hitch and the main frame. Accordingly, the rigid hitch assembly may enable transport of the agricultural implement system at a high speed between agricultural fields. However, during operation within the field, due to the rigidity of the hitch assembly with respect to the main frame of the implement, the penetration depth of the ground engaging tools may vary as the agricultural implement system traverses uneven terrain. Accordingly, in certain cases (e.g., traversing an uneven field), using a rigid hitch assembly may not provide effective preparation of the soil.

In the embodiments disclosed herein, the hitch assembly is configured to transition between a floating mode and a rigid mode. With the hitch assembly in the floating mode, hydraulic fluid may flow freely within an actuating cylinder of the hitch assembly, thereby enabling the main frame of the implement to move with respect to the hitch during operation of the agricultural implement system. As such, operation of the hitch assembly in the floating mode may enable the implement to better follow (e.g., comparative to the rigid mode) ground contours (e.g., hills, valleys, grade) of the field. Accordingly, ground engaging tools of the implement may engage the soil at a substantially constant depth within the field, thereby increasing precision of the soil preparation process (e.g., plowing, cultivating, and the like). Furthermore, with the hitch assembly in the rigid mode, the agricultural implement may be operated at higher speeds for transport due to the constant angle between the hitch and the main frame of the implement.

The agricultural implement system may include a valve assembly to facilitate dynamic switching between the modes. The valve assembly is configured to control an actuating cylinder of the hitch assembly to transition the hitch assembly between the floating mode and the rigid mode. The valve assembly may transition the hitch assembly to the floating mode while the agricultural implement system is in a working position, and the valve assembly may transition the hitch assembly to the rigid mode while the agricultural implement system is in a non-working position. The working position may be used for agricultural operations and the non-working position may be used for transport (e.g., in-field transport, road transport, storage) of the agricultural implement system. The agricultural implement system may also include a control assembly communicatively coupled to the valve assembly. The control assembly may be configured to transition the agricultural implement system between the working position and the non-working position. In addition, in response to determining that the agricultural implement system is in the working position, the control assembly may control the valve assembly to engage the floating mode, thereby enabling hydraulic fluid to flow freely into and out of the actuating cylinder. In some instances, the control assembly may receive sensor feedback indicative of the position of the agricultural implement system and control the valve assembly based on the position.

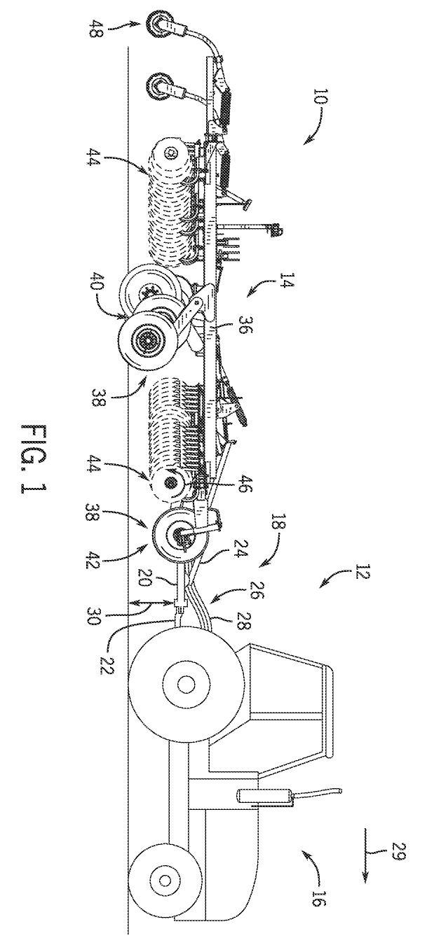

With the foregoing in mind, FIG. 1 is a side view of an embodiment of an agricultural system 10 having an agricultural implement system 12. The agricultural implement system includes an implement 14 that is configured to be towed behind a work vehicle 16, such as the illustrated tractor. In the illustrated embodiment, the implement 14 includes a hitch assembly 18 configured to couple a hitch 20 at a first end of the implement 14 to an appropriate tractor hitch 22. The hitch assembly 18 also includes an actuating cylinder 24 that may be controlled to dynamically change between modes of the hitch assembly 18. For example, the modes may include a rigid mode and a floating mode. The rigid mode may be engaged when the agricultural implement system 12 is in a non-working position. Further, the floating mode may be engaged when the agricultural implement system 12 is in a working position.

In the illustrated embodiment, the agricultural implement system 12 also includes a valve assembly 26 configured to control the hitch assembly 18 via the actuating cylinder 24. In some instances, the valve assembly 26 may include one or more fluid conduits 28, one or more valves, and the like. As discussed in detail below, the valve assembly 26 may enable an operator and/or a control assembly to control the mode of the hitch assembly 18. For example, the operator and/or the control assembly may control the valve assembly 26 to transition the hitch assembly 18 between the floating mode and the rigid mode. In addition, as discussed in detail below, the valve assembly 26 may control the hitch assembly 18 to adjust a height 30 of the implement 14 relative to the ground 32.

In the illustrated embodiment, the implement 14 is a vertical tillage implement, and the work vehicle 16 may tow the implement along a direction of travel 29. As illustrated, the agricultural implement system 12 is in a non-working position. As will be described, the hitch assembly 18 may be transitioned to the rigid mode while the agricultural implement system 12 is in the non-working position (e.g., transport mode). In the illustrated embodiment, the implement 14 includes a main frame 36. The main frame 36 is coupled to the hitch 20 at the front end (e.g., tractor end) of the implement 14. In some embodiments, when the agricultural implement system 12 is in the non-working position, as illustrated in FIG. 1, ground-engaging tools of the implement are disengaged from the soil, and the hitch assembly 18 may be operated in the rigid mode. The rigid mode may substantially block pivoting of the main frame 36 about center wheels, thereby enhancing the stability of the implement while being transported at higher speeds. In certain embodiments, when the agricultural implement system 12 is in the non-working position, one or more wings of the implement 14 may fold up to create a narrow transport width to facilitate transport of the agricultural implement system 12. The rigid mode of the hitch assembly 18 may be engaged concurrently with transitioning the agricultural implement system 12 to the non-working position and folding the wing(s) to the narrow transport width.

In the illustrated embodiment, sets of wheels 38 are connected to the main frame 36 of the implement 14 of the agricultural implement system 12. The sets of wheels 38 include a set of center wheels 40 and a set of stabilizer wheels 42. In certain embodiments, the implement may include more or fewer sets of wheels to facilitate balance and/or operation of the implement. In the illustrated embodiment, each wheel of the set of center wheels 40 is attached to the main frame 36 at a position, for example, about midway between the front end and a rear end of the main frame 36. Each wheel of the set of stabilizer wheels 42 is connected to a front distal end of the main frame 36. The set of stabilizer wheels 42 may include at least two stabilizer wheels that reduce the amount of movement of the implement 14 as the implement is towed through the field while the agricultural implement system 12 is in the working position. The agricultural implement system includes actuators configured to drive the wheels of the set of center wheels 40 to move upwardly and downwardly relative to the main frame 36. Driving the wheels of the set of center wheels 40 downwardly transitions the agricultural implement system 12 to the illustrated non-working position, and driving the wheels of the set of center wheels 40 upwardly transitions the agricultural implement system 12 to the working position.

In the illustrated embodiment, the implement 14 also includes two rows of disc blades 44 (e.g., fluted-concave disc blades, etc.) attached to the main frame 36. While the agricultural implement system 12 is in the working position, the disc blades 44 engage the soil. Accordingly, movement of the implement 14 in the direction of travel 29 drives the disc blades 44 to rotate in a direction of rotation 46, thereby breaking up the top layer of the soil. Furthermore, while the agricultural implement system 12 is in the illustrated non-working position, the disc blades 44 are disengaged from the soil. In some embodiments, when the agricultural implement system 12 is in the working position, the hitch assembly 18 operates in the floating mode. The floating mode of the hitch assembly 18 enables the implement 14 to pitch forwardly and rearwardly about the set of center wheels 40, thereby enabling the disc blades 44 to follow the contours of the field. Moreover, the implement 14 may include rolling basket assemblies 48. The rolling basket assemblies 48 are connected to the rear end of the main frame 36 to provide downward pressure. In some embodiments, the rolling basket assemblies 48 may be replaced with any other suitable device(s) capable of exerting a desired downward pressure, including finishing discs, tines, and the like.

As illustrated in FIG. 1, the agricultural implement system 12 is in the non-working position, and the hitch assembly 18 operates in the rigid mode. In certain embodiments, the agricultural implement system 12 may dynamically switch between operating the hitch assembly 18 in the working mode and operating the hitch assembly 18 in the non-working mode. For example, transitioning the agricultural implement system 12 to the illustrated non-working position from the working position may cause a linkage assembly to drive the valve assembly 26 to a rigid state. While in the rigid state, the valve assembly may be controlled to maintain a constant level between the front end and the back end of the implement 14 or maintain a constant angle between the hitch 20 of the implement and the main frame 36. Furthermore, in certain embodiments, the valve assembly 26 may control the transition of the agricultural implement system 12 from the working position to the non-working position. Accordingly, the valve assembly 26 may control the actuators coupled to the set of center wheels 40 to move downwardly, thereby driving the rows of disc blades 44 to disengage the soil. The valve assembly 26 may also transition to the rigid state, thereby causing the hitch assembly 18 to operate in the rigid mode. While operating the hitch assembly 18 in the rigid mode while the implement 14 is in the illustrated non-working position is discussed herein, in some instances the hitch assembly 18 may be operated in the rigid mode while the implement 14 is in the working position.

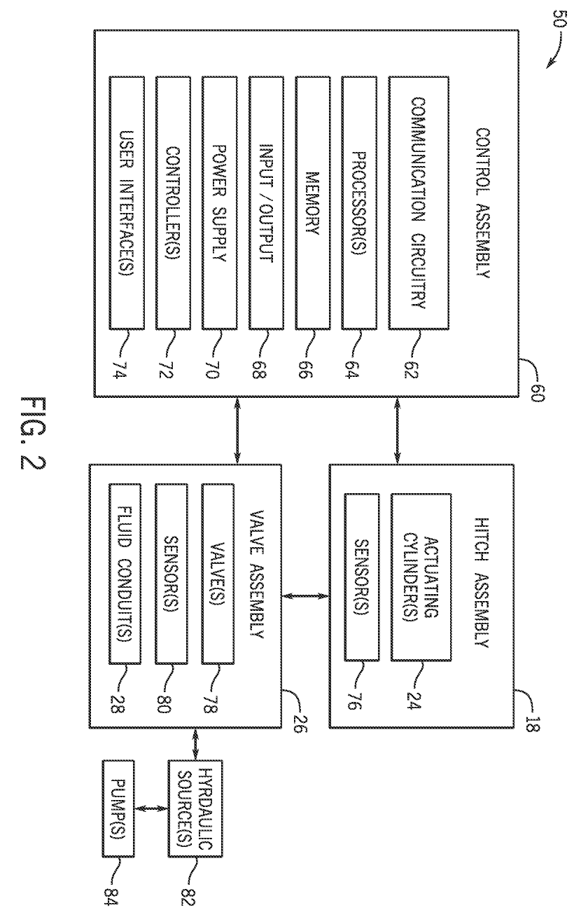

FIG. 2 is a block diagram of an embodiment of a control system 50 that may be employed within the agricultural system of FIG. 1. The control system 50 includes a control assembly 60, the hitch assembly 18, and the valve assembly 26. The control assembly 60 may include communication circuitry 62, one or more processors 64, a memory 66, an input/output (I/O) 68, a power supply 70 (e.g., wired power, a battery), one or more controllers 72, one or more user interfaces 74, and the like. The hitch assembly 18 includes one or more actuating cylinders 24 (e.g., actuator(s)), and in certain embodiments, one or more sensors 76. The valve assembly 26 includes one or more valve(s) 78, and in certain embodiments, one or more sensors 80 and/or one or more fluid conduits 28.

The communication circuitry 62 may facilitate wired or wireless communication between various components of the control assembly 60, as well as with external device(s), such as a mobile device, or central or local controller(s) of the agricultural system. The processor(s) 64 may include any suitable type of computer processor(s) and/or microprocessor(s) capable of executing computer-executable code. Moreover, the processor(s) 64 may include multiple microprocessors, one or more “general-purpose” microprocessors, one or more special-purpose microprocessors, and/or one or more application specific integrated circuits (ASICS), or some combination thereof. For example, the processor(s) 64 may include one or more than one reduced instruction set (RISC) or complex instruction set (CISC) processors. In some embodiments, the processor(s) 64 may receive inputs (e.g., signals) from the sensor(s) 76 of the hitch assembly 18 (e.g., via the communication circuitry 62). For example, the agricultural implement system may be in the working position, and the sensor(s) 76 may output sensor feedback data indicative of the agricultural implement system being in the working position. As such, the control assembly 60 may receive communication (e.g., the signal(s), sensor feedback data) associated with the implement from the sensor(s) 76 and control the valve assembly 26 to operate the hitch assembly 18 in the floating mode. In some instances, the control assembly 60 may be positioned inside a cab of the work vehicle.

The memory 66 of the control assembly 60 may also be used to store instructions, the data, various other software applications, and the like that are executed by the processor(s) 64. The memory 66 may represent non-transitory computer-readable media (e.g., any suitable form of memory or storage) that may store the processor-executable code used by the processor(s) 64 to perform various techniques described herein. The I/O 68 may include interface(s) that may couple to other peripheral component(s), such as input device(s) (e.g., keyboard, mouse), sensor(s), input/output (I/O) module(s), and the like. The power supply 70 may provide power to one or more components of the control assembly 60. The component(s) of the control assembly 60 may be coupled to the work vehicle, the implement, any other suitable component(s) of the agricultural system, or a combination thereof.

In some embodiments, the user interface 74 is configured to display real time or near real time information (e.g., hydraulic fluid pressure(s) and/or flow(s), work vehicle speed, hitch assembly operating mode, implement position, etc.) to the operator in a cabin of the work vehicle. Additionally or alternatively, the user interface 74 may present information at a remote operator station. Moreover, the user interface 74 may enable the operator to input commands to the processor(s) 64 to control operation of the implement and/or the tractor. For example, the operator may control the valve assembly 26 based on anticipated terrain conditions while the hitch assembly 18 is operating in the rigid mode. The operator may also control the valve assembly 26 to switch between the rigid and floating modes of the hitch assembly 18. Furthermore, in certain embodiments, the user interface 74 is a “touch screen” or interactive type of display (e.g., liquid crystal display, light emitting diode display, etc.) that is configured to receive inputs from the operator. For example, in some embodiments, the user interface 74 is a capacitive touch screen with haptic feedback. However, other types of technology may be used to receive operator input, including infrared, resistive, piezoelectric, and the like.

The valve assembly 26 may control hydraulic fluid pressure and/or flow to actuators (e.g., the hitch actuating cylinder 24, the center wheel actuator(s), etc.) within the implement. For example, hydraulic sources 82 may be fluidly coupled to the valve(s) 78 (e.g., electro-hydraulic remote valve(s)), and the valve(s) may control the hydraulic fluid pressure within the hitch actuating cylinder 24 (e.g., in the rigid mode) or enable the hitch actuating cylinder 24 to move freely (e.g., in the floating mode). The valve assembly 26 may receive a signal from the control assembly 60 indicating that the agricultural implement system 12 is transitioning from the non-working position to the working position. In some instances, the control assembly 60 may control the valve(s) 78 to enable the actuating cylinder 24 to move freely (e.g., in response to the agricultural implement system 12 reaching the working position), thereby enabling the hitch assembly to operate in the floating mode. For example, the control assembly 60 may control the valve(s) 78 to open to enable the hydraulic fluid within the actuating cylinder 24 to flow freely, thereby enabling the hitch assembly to operate in the floating mode (e.g., enabling the hitch to float). In the floating mode, leveling of the main frame of the implement may be controlled by controlling the height of the stabilizer wheels and/or the center wheels (e.g., by controlling respective wheel actuator(s)). Accordingly, while the agricultural implement system 12 is in the working position (e.g., while performing agricultural operations within the field), the actuating cylinder 24 of the hitch assembly 18 is free to retract and/or extend, thereby enabling the implement to follow contours of the field. For example, the field may include one or more hills with various inclines. As such, the floating mode enables the ground engaging tools of the agricultural implement system to maintain a substantially constant working depth along the hills, thereby establishing an even tillage depth as the implement moves through the field.

In some embodiments, the control assembly 60 receives an indication (e.g., operator input, sensor signal, or the like) that the agricultural implement system 12 is transitioning from the working mode to the non-working mode. In response, the control assembly 60 controls the valve assembly 26 to initiate the rigid mode. In some instances, the control assembly may control additional hydraulic actuator(s) simultaneously, concurrently, and/or sequentially with activation of the floating mode and/or the rigid mode. Accordingly, the control assembly 60 may control additional valve(s) to control hydraulic fluid flow to one or more additional hydraulic actuators (e.g., wing actuators, etc.) to facilitate movement and/or operation of one or more components of the implement (e.g., drive wings of the implement to extend or retract, etc.).

For example, the control assembly 60 may initiate the rigid mode by controlling the valve(s) 78 associated with the actuating cylinder 24 to close in response to receiving instructions to transition to the non-working position or in response to detecting the transition to the non-working position, thereby blocking hydraulic fluid flow to and from the hitch actuating cylinder 24. Furthermore, in some instances, the control assembly 60 may control the valve(s) associated with certain actuator(s) to retract (e.g., wing actuators to drive the wings to fold upwardly) in response to receiving instructions to transition to the non-working position or in response to detecting the transition to the non-working position. In addition, in some instances, the control assembly 60 may control the valve(s) of certain actuator(s) to extend (e.g., wheel actuators to drive the center wheels downwardly to elevate the main frame of the implement) in response to receiving instructions to transition to the non-working position or in response to detecting the transition to the non-working position. For example, in response to receiving instructions to transition to the non-working position, the control assembly 60 may control valves to control actuators to lower the center wheels, which transitions the agricultural implement system 12 to the non-working position, to retract the wings, which folds the wings of the implement upwardly for transport, and to transition the hitch assembly to the rigid mode, which blocks rotation of the hitch relative to the main frame of the implement. In certain embodiments, the hitch assembly may be transitioned to the rigid mode by closing the valve(s) 78 associated with the actuating cylinder 24 when the additional hydraulic actions of the agricultural system (control of the wheel actuators and the wing actuators) are complete. In this manner, the rigid mode is engaged once the implement is in the non-working position.

In some embodiments, pump(s) 84 are configured to flow hydraulic fluid from the hydraulic source(s) 82 to the valve assembly 26. In this manner, the pump(s) 84 may receive a signal from the control assembly 60 indicating that the agricultural implement system 12 is transitioning from the non-working position to the working position and/or from the working position to the non-working position. In response, the pump(s) 84 may activate or increase capacity to provide sufficient hydraulic fluid to the actuator(s).

In some embodiments, the sensor(s) 76 of the hitch assembly 18 and/or the sensor(s) 80 of the valve assembly 26 may send signals (e.g., indicative of sensor feedback data) to the control assembly 60, and the control assembly 60 may activate the floating mode or the rigid mode based on feedback from the sensor(s). The sensors 76, 80 may include pressure sensor(s), ground speed sensor(s), wheel position sensor(s), location sensor(s) (e.g., GPS), penetration depth sensor(s), and the like. The sensor(s) 76 (e.g., pressure sensor(s)) of the hitch assembly 18 may output signal(s) indicative of a fluid pressure within the actuating cylinder 24 in the rigid mode. Additionally or alternatively, the sensor(s) 80 (e.g., penetration depth sensor) of the valve assembly 26 may output signal(s) indicative of the working depth of the ground engaging tools of the implement. The control assembly 60 may activate the floating mode after (e.g., a predetermined delay after) the ground engaging tools of the implement reach the working depth associated with the working position of the agricultural implement system. In some instances, the control assembly 60 may activate the floating mode when the wheel position sensor outputs a signal to the control system 60 indicating that the agricultural implement system is in the working position. In some embodiments, the operator may initiate the rigid mode or the floating mode via input to the user interface(s) 74.

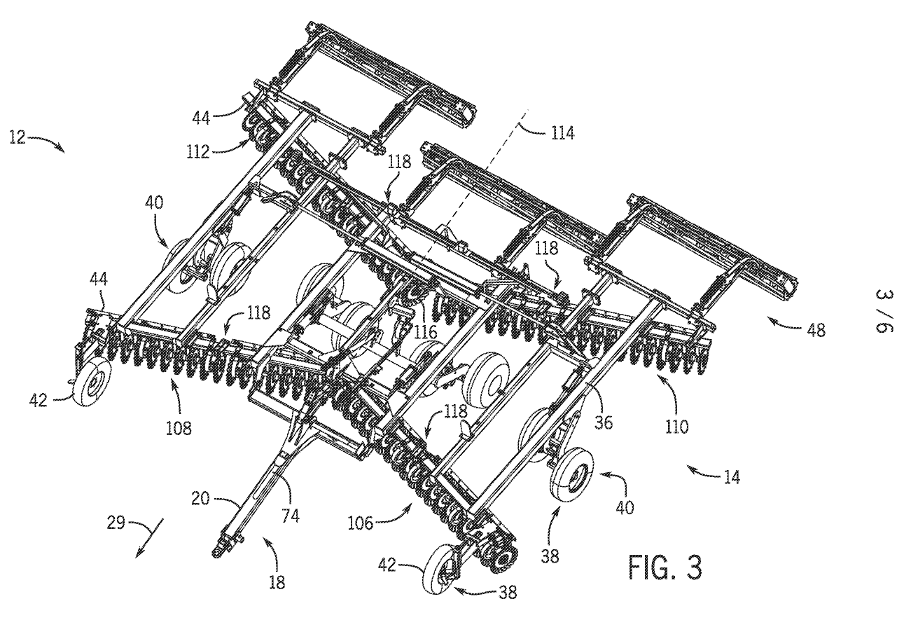

FIG. 3 is a perspective view of the agricultural implement system 12 of FIG. 1. As illustrated, the agricultural implement system 12 includes the implement 14 (e.g., vertical tillage implement). The implement 14 includes the hitch assembly 18 (e.g., including the hitch 20), the main frame 36, the sets of wheels 38, the rows of disc blades 44, and the rolling basket assemblies 48. The hitch assembly 18 includes the actuating cylinder 24 coupled to the hitch 20. In some embodiments, the actuating cylinder 24 of the hitch assembly 18 is controlled by the control assembly.

With the foregoing in mind, in the working position, the hitch assembly 18 of the implement 14 may operate in the floating mode. The floating mode may enable the main frame 36 of the implement 14 to pivot about the center wheels 40 as the agricultural implement system 12 traverses the field. The control assembly may control the valve assembly to activate the floating mode, thereby enabling the implement 14 to follow contours of the field. In accordance with one configuration, the rows of disc blades 44 are indexed. For example, the rows of disc blades 44 include a front row having a front left portion 106 and a front right portion 108, and a rear row having a rear left portion 110 and a rear right portion 112. When indexed, the front left portion 106 and the front right portion 108 are aligned with the rear left portion 110 and the rear right portion 112, respectively, such that areas of ground between adjacent pairs of disc blades of the front left portion 106 and the front right portion 108 are engaged by the disc blades of the rear left portion 110 and the rear right portion 112 as the implement 14 moves along the direction of travel 29 while the hitch assembly 18 is in the floating mode.

In the illustrated configuration, the front left portion 106 and the rear left portion 110 are symmetric about a centerline 114 of the implement 14 with the front right portion 108 and the rear right portion 112, respectively. Because the rows of disc blades 44 are arranged in a symmetrical arrangement about the centerline 114, a gap between each side of the symmetrical rows may be created. A center tilling member 116 may be placed in this gap to engage soil between the left and right portions as the implement moves in the direction of travel. The center tilling member 116 may be a coulter, another fluted disc blade, or the like. Moreover, the rows of disc blades are balanced due to their symmetry, and front and rear rows on both the right and left sides cover separate paths along the field.

Although the implement 14 includes four portions of disc blades 44 in the illustrated embodiment, in other embodiments, the implement may include fewer or more portions of disc blades. Additionally, while the portions of disc blades 44 are arranged in an x-shaped configuration based on the described symmetry in the illustrated embodiment, in other embodiments, the portions of disc blades 44 may have a different configuration. For example, the portions of disc blades 44 may be arranged in a diamond configuration, a k-shaped configuration, or all portion may be parallel with each other in a direction perpendicular to the direction of travel.

In some embodiments, wings of the main frame 36 of the implement 14 may fold into a transport configuration (e.g., via rotation of the wings about joints 118). In some embodiments, actuators drive the wings to fold upwardly when the agricultural implement system is in the non-working position. However, in some embodiments, the implement may not include foldable wings. Furthermore, in certain embodiments, an implement having foldable wings may be transported within a particular field from a first location to a second location without folding the wings.

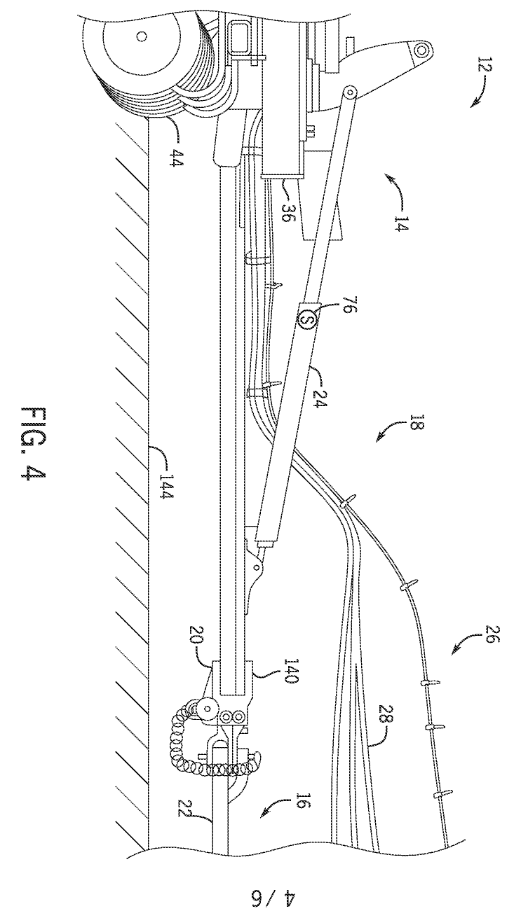

FIG. 4 is a side view of a portion of the agricultural implement system 12 of FIG. 1 in the working position. In the illustrated embodiment, the hitch assembly 18 includes a hitch frame 140 and the hitch 20 (e.g., implement hitch), which is coupled to the tractor hitch 22 of the work vehicle 16. The hitch assembly 18 is positioned at a first end of the main frame 36 of the implement 14. Furthermore, the hitch assembly 18 includes the actuating cylinder 24 that may be controlled to change between modes (e.g., floating mode, working mode) of the hitch assembly 18 based on a position (e.g., working position, non-working position) of the agricultural implement system 12. In FIG. 4, the pair of stabilizer wheels is omitted for clarity. As illustrated, the actuating cylinder 24 is coupled to the main frame 36 of the implement 14 and to the hitch frame 140. While the agricultural implement system 12 includes a single actuating cylinder 24 in the illustrated embodiment, in other embodiments, the agricultural implement system 12 may include additional actuating cylinders extending between the main frame 36 and the hitch frame 140. Furthermore, while the actuating cylinder 24 is coupled to the hitch frame 140 in the illustrated embodiment, in other embodiments, the actuating cylinder 24 may be coupled directly to the hitch 20 or another suitable element of the hitch assembly 18.

As illustrated, the agricultural implement system is in the working position. The control assembly is communicatively coupled to the sensor(s) 76 and to the actuating cylinder 24 (e.g., via the valve assembly). The control assembly is configured to engage the floating mode when the agricultural implement system is in the working position. As a result, the main frame 36 may be substantially maintained at an orientation that is parallel to a soil surface 144 along the fore-aft/longitudinal direction during operation of the implement 14 (e.g., as compared to a main frame that is substantially maintained in a level orientation perpendicular to the direction of gravitational acceleration). Accordingly, at least a portion of the rows of disc blades 44 (e.g., ground engaging tools) may be substantially maintained at a target penetration depth beneath the soil surface 144, thereby enhancing the effectiveness of agricultural operations (e.g., as compared to an agricultural implement system having a rigid hitch assembly that causes the implement to tilt relative to the soil surface during operation, thereby causing the penetration depth of the ground engaging tools to vary).

In some embodiments, the hydraulic source(s) of the work vehicle 16 supply a working fluid (e.g., hydraulic fluid) to the actuator(s) of the agricultural implement system via one or more fluid conduits 28. The actuator(s) (e.g., the actuating cylinder 24, the wheel actuators, the wing actuators, etc.) receive the working fluid from the hydraulic source(s). The agricultural implement system may have a variety of systems driven by the working fluid (e.g., hydraulic fluid) supplied by the hydraulic source(s). The valve assembly 26 may control opening and/or closing of valves to control fluid flow and/or fluid pressure within the actuator(s). For example, while the agricultural implement system is in the working position, the valve assembly may control valve(s) to enable the working fluid to flow freely into and out of the actuating cylinder 24 without being trapped or pressurized, thereby operating the hitch assembly in the floating mode.

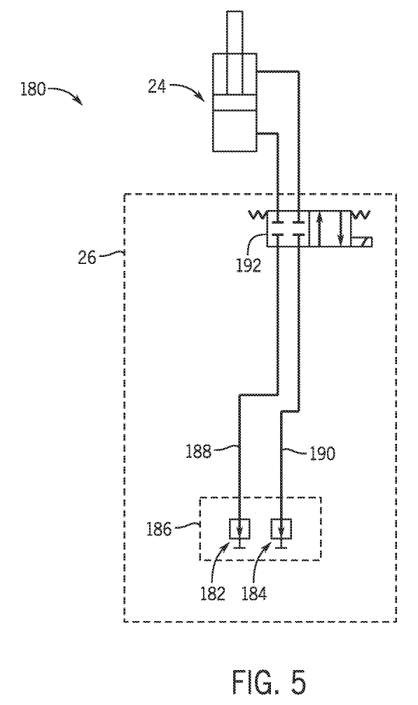

FIG. 5 is a schematic diagram of an embodiment of a hydraulic circuit 180 that may be employed within the agricultural implement system of FIG. 1. The hydraulic circuit 180 includes an embodiment of the valve assembly 26, as described above with reference to FIG. 2. The valve assembly 26 of the hydraulic circuit 180 includes a first hydraulic fluid input 182 and a second hydraulic fluid input 184. The first hydraulic fluid input 182 is configured to provide hydraulic fluid for extension of the actuating cylinder 24 of the hitch assembly, which is a double acting hydraulic cylinder. The second hydraulic fluid input 184 is configured to provide hydraulic fluid for retraction of the actuating cylinder 24 of the hitch assembly. In some embodiments, the control assembly, as disclosed above with reference to FIG. 2, may control hydraulic fluid flow through the first and second hydraulic fluid inputs 182, 184.

As shown, the first and second hydraulic fluid inputs 182, 184 of the hydraulic circuit 180 are fluidly coupled to a hydraulic system 186 of the work vehicle coupled to the agricultural implement system. The hydraulic system 186 of the work vehicle may provide hydraulic fluid to the hydraulic circuit 180 and receive hydraulic fluid from the hydraulic circuit via supply lines. One supply line may be fluidly coupled to the first hydraulic fluid input 182, and one supply line may be coupled to the second hydraulic fluid input 184. In addition, the valve assembly 26 includes a first hydraulic conduit 188 extending from the first hydraulic fluid input 182, and a second hydraulic conduit 190 extending from the second hydraulic fluid input 184.

In the illustrated embodiment, the valve assembly 26 of the hydraulic circuit 180 includes a directional control valve 192 configured to control the flow of hydraulic fluid between the hydraulic system 186 and the hitch actuating cylinder 24. Furthermore, in the illustrated embodiment, the directional control valve 192 is an on/off blocking valve, which may be positioned on the implement. The directional control valve 192 is a four-way, two-position directional control valve that is fluidly coupled to the first hydraulic conduit 188 and to the second hydraulic conduit 190. In a first position, as illustrated, the directional control valve 192 is closed and configured to block the flow of hydraulic fluid between the hydraulic system 186 and the hitch actuating cylinder 24. With the directional control valve 192 in the illustrated first position, the hitch assembly is operating in the rigid mode. As such, rotation of the hitch relative to the main frame of the implement is blocked, thereby enabling the implement to be towed at a higher speed during transport. With the directional control valve 192 in the second position, the hitch assembly is operating in the floating mode. As such, the hitch may rotate relative to the main frame of the implement, thereby enhancing the ability of the implement to follow contours of the field during agricultural operations. In the illustrated embodiment, the position of the directional control valve 192 is controlled by a solenoid, which is communicatively coupled to the control assembly. However, in other embodiments, the directional control valve may be controlled by a hydraulic pilot, a pneumatic pilot, a lever, or another suitable actuator.

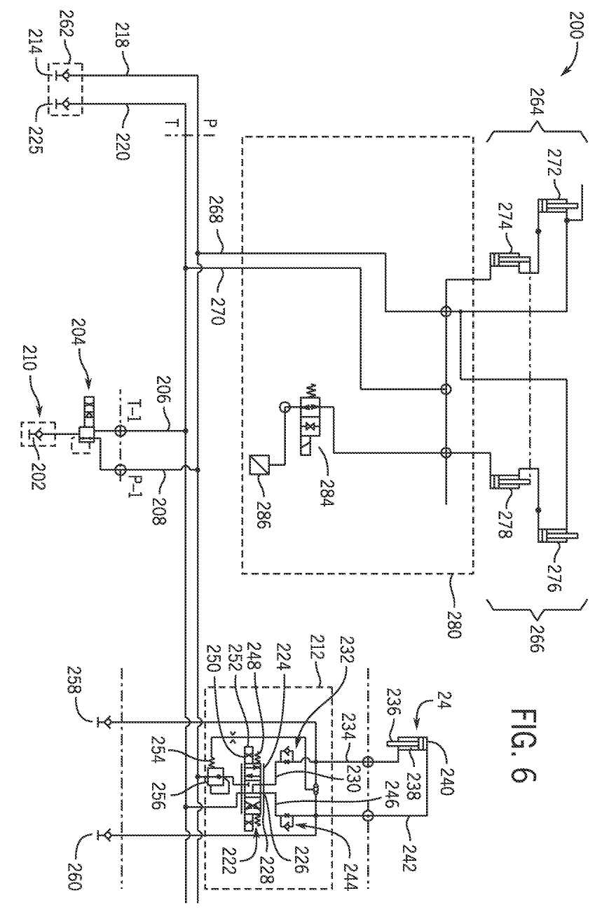

FIG. 6 is a schematic diagram of an embodiment of a hydraulic circuit 200 that may be employed within the agricultural implement system of FIG. 1. In the illustrated embodiment, the hydraulic circuit 200 controls the mode (e.g., rigid mode, floating mode) of the hitch assembly and controls the position of the agricultural implement system (e.g., working position, non-working position). The hydraulic circuit 200 includes a first hydraulic fluid input 202. The first hydraulic fluid input 202 is configured to provide hydraulic fluid to the actuating cylinder 24 of the hitch assembly. The first hydraulic fluid input 202 is fluidly couple to a solenoid controlled pressure relieving valve 204. The solenoid controlled pressure relieving valve 204 is configured to control pressure of the hydraulic fluid supplied to the actuating cylinder 24 of the hitch assembly. The solenoid controlled pressure relieving valve is fluidly coupled to the hitch actuating cylinder 24 via a first fluid conduit 206 and a second fluid conduit 208. As shown, the first hydraulic fluid input 182 is fluidly coupled to a hydraulic system 210 of the work vehicle coupled to the agricultural implement system. The hydraulic system 210 of the work vehicle may provide hydraulic fluid to the hydraulic circuit 200 via a supply line.

In the illustrated embodiment, the hydraulic circuit 200 includes a hitch assembly circuit 212 configured to control the actuating cylinder 24 of the hitch assembly independently of one or more other actuators. The hitch assembly circuit 212 may receive hydraulic fluid from the hydraulic system 210 of the work vehicle via the second fluid conduit 208. Additionally, the hydraulic circuit 200 includes a second hydraulic fluid input 214, which is fluidly coupled to the hitch assembly circuit 212 via a third fluid conduit 218. As illustrated, the second fluid conduit 208 is fluidly coupled to the third fluid conduit 218. Further, a fourth fluid conduit 220 fluidly couples a third hydraulic fluid input 225 to the hitch assembly circuit 212, and the first fluid conduit 206 is fluidly coupled to the fourth fluid conduit 220. The hitch assembly circuit 212 includes a first directional control valve 222 configured to control the flow of hydraulic fluid into appropriate fluid conduits for dynamically controlling the mode of the hitch assembly (e.g., rigid mode, floating mode). The first directional control valve 222 is a four-way, three-position solenoid controlled valve. The first directional control valve 222 includes a first position 224, a second position 226, and a third position 228. While the first directional control valve 222 is in the first position 224, hydraulic fluid may flow from the third fluid conduit 218 along a first valve output line 230, through a first flow controller 232, and through a second valve output line 234. The first flow controller 232 is configured to control flow of the hydraulic fluid.

The second valve output line 234 is fluidly coupled to a rod end 238 of the actuating cylinder 24 of the hitch assembly. By introducing hydraulic fluid to the rod end 238, a piston rod 236 is driven to retract. As the cylinder retracts, hydraulic fluid is driven from a cap end 240 of the actuating cylinder 24 into a third valve output line 242. With the first directional control valve 222 in the first position 224, the hydraulic fluid passes through a second flow controller 244, through a fourth valve output line 246, and flows to the third hydraulic fluid input 225 via the fourth fluid conduit 220. With the first directional control valve 222 in the first position, the flow through the third and fourth fluid conduits 218, 220 may be controlled (e.g., blocked) at a hydraulic source 262, such that the hitch assembly operates in the rigid mode. When the first directional control valve 222 is in the second position 226, the cap end 240 and the rod end 238 of the actuating cylinder 24 are fluidly coupled to the fourth fluid conduit 220, thereby enabling hydraulic fluid to flow through the valve output lines 230, 234, 242, 246 and the fourth fluid conduit 220 to the third hydraulic fluid input 225. As a result, hydraulic fluid may flow from the cap end 240 and the rod end 236 of the actuating cylinder 24 to the third hydraulic fluid input 225, such that the hitch assembly operates in the floating mode.

While the first directional control valve 222 is in the third position 228, hydraulic fluid is enabled to flow in an opposite direction as when the first directional control valve 222 is in the first position 224. For example, while the first directional control valve 222 is in the third position 228, hydraulic fluid may flow from the second hydraulic fluid input 214 to the third valve output line 242. The third valve output line 242 is fluidly coupled to the cap end 240 of the actuating cylinder 24. Accordingly, hydraulic fluid may be introduced to the cap end 240, thereby driving the piston rod 236 to extend. As the piston rod extends, hydraulic fluid is pushed from the rod end 238 into the second valve output line 234. The hydraulic fluid then passes through the first flow controller 232, through the first valve output line 230, and through the fourth fluid conduit 220 to the third hydraulic fluid input 225. With the first directional control valve 222 in the third position, the flow through the third and fourth fluid conduits 218, 220 may be controlled (e.g., blocked) at the hydraulic source 262, such that the hitch assembly operates in the rigid mode. The position of the hitch relative to the main frame may be adjusted by moving the first directional control valve 222 between the first and third positions (e.g., such that the hitch is in a desired position while the hitch assembly is in the rigid mode). In some embodiments, the first directional control valve 222 includes various biasing springs 248 and solenoids 250 to control the position of the first directional control valve 222. For example, the solenoids 250 may be communicatively coupled to the control assembly, as disclosed above with reference to FIG. 2, and the control assembly may control the solenoids to provide a force that may overcome a force of the biasing springs 248, thereby driving the first directional control valve 222 to the first position 224 or to the third position 228.

As shown, the first directional control valve 222 includes a shuttle valve 252 configured to transfer a fluid pressure from the rod end 236 or the cap end 240 of the actuating cylinder 24 to a spring end 254 of a pressure reducing valve 256, which is fluidly coupled to the second supply line. The pressure reducing valve 256, as controlled by the shuttle valve 252, is configured to establish a substantially constant pressure differential across the first directional control valve 222, thereby facilitating a fluid flow more linearly related to the position of the first directional control valve 222. As such, output and/or performance of the first directional control valve 222 may be more consistent. In some embodiments, the hitch assembly circuit 212 may include one or more override couplers 258, 260. The first override coupler 258 may be directly fluidly coupled to the rod end 236 of the actuating cylinder 24 via the second valve output line 234. Further, the second override coupler 260 may be directly fluidly coupled to the cap end 240 of the actuating cylinder 24 via the third valve output line 242. The override couplers may enable direct control of the actuating cylinder 24 (e.g., to operate the hitch assembly in the floating mode or the rigid mode).

In some embodiments, the hydraulic circuit 200 may include hydraulic controls to control the position of the main frame of the implement. The position of the main frame may be controlled while the hitch assembly is in the floating mode and/or the rigid mode. The hydraulic circuit 200 may control the position of the pair of stabilizer wheels and/or the center wheels of the implement to control the penetration depth of the ground engaging tools and to transition the agricultural implement system between the working and non-working positions. As such, the hydraulic source 262 may provide hydraulic fluid to actuator(s) to control the position of the stabilizer wheels and/or the center wheels. For example, to transition the agricultural implement system from the working position to the non-working position, the center wheels may be lowered, thereby raising the main frame, and, in certain embodiments, the stabilizer wheels may be raised. Furthermore, the hydraulic source 262 may provide hydraulic fluid to wing fold cylinders to selectively fold the wings of the implement for transport. For example, the hydraulic source 262 may provide hydraulic fluid to one or more right side cylinders 264 and one or more left side cylinders 266 via a first wing conduit 268 or a second wing conduit 270. The right side cylinders 264 may include a right-wing fold cylinder 272 and a right center wheel lift cylinder 274. In addition, the left side cylinders 266 may include a left-wing fold cylinder 276 and a left center wheel lift cylinder 278. The hydraulic source 262 is configured to provide hydraulic fluid for controlling the right side cylinders 264 and the left side cylinders 266.

The wing conduit 268 is fluidly coupled to the rod ends of the right-wing fold cylinder 272 and the left-wing fold cylinder 276. In addition, the cap end of the right-wing fold cylinder 272 is fluidly coupled to the rod end of the right center wheel lift cylinder 274, and the cap end of the left-wing fold cylinder 276 is fluidly coupled to the rod end of the left center wheel lift cylinder 278. Accordingly, fluid may be provided to the second hydraulic fluid input 214 to directly control retraction of the cylinders. Furthermore, the second wing conduit 270 is fluidly coupled to the cap ends of the right center lift cylinder 274 and the left center lift cylinder 278. Therefore, fluid may be provided to the third hydraulic fluid input 225 to directly control extension of the cylinders.

In the illustrated embodiment, the valve assembly 280 includes a second directional control valve 284 fluidly coupled to the second wing conduit 270. The second directional control valve 284 is fluidly coupled to the second wing conduit 270 and to an override pressure sensor 286. In a first position, the second directional control valve 284 fluidly couples the second wing conduit 270 to the override pressure sensor 286. In a second position, the second directional control valve 284 blocks fluid flow to the override pressure sensor 286. The override pressure sensor 286 may be communicatively coupled to the control assembly and configured to output a signal indicative of a height of the implement relative to the soil surface. Accordingly, the control assembly may control the first directional control valve 222 based on feedback from the override pressure sensor 286. For example, in response to receiving a signal from the override pressure sensor 286 indicative of the agricultural implement system being in the working position, the control assembly may control the first directional control valve 222 to transition the hitch assembly into the floating mode. In addition, in response to receiving a signal from the override pressure sensor 286 indicative of the agricultural implement system being in the non-working position, the control assembly may control the first directional control valve 222 to transition the hitch assembly into the rigid mode.

While the control assembly is configured to control the valve assembly to control the hitch actuating cylinder in the embodiments disclosed above, in certain embodiments, the control assembly may control a hitch actuator directly. For example, in certain embodiments, the hitch actuator may include an electromechanical actuator. In such embodiments, the control assembly may control the hitch actuator to transition the hitch assembly between the floating mode and the rigid mode.

While only certain features have been illustrated and described herein, many modifications and changes will occur to those skilled in the art. It is, therefore, to be understood that the appended claims are intended to cover all such modifications and changes as fall within the true spirit of the disclosure. It should be appreciated that any of the features illustrated or described with respect to the figures discussed above may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. An agricultural implement system, comprising:
a hitch assembly comprising:
a hitch configured to couple the agricultural implement system to a work vehicle; and
an actuator configured to control the hitch; and
a control assembly communicatively coupled to the actuator, wherein the control assembly comprises a memory configured to store instructions and one or more processors, wherein the control assembly is configured to control the actuator to operate the hitch assembly in a floating mode while the agricultural implement system is in a working position and to operate in a rigid mode while the agricultural implement system is in a non-working position.

2. The agricultural implement system of claim 1, wherein a main frame of an implement of the agricultural implement system is configured to follow contours of a field while the hitch assembly is in the floating mode.

3. The agricultural implement system of claim 1, comprising one or more sensors configured to output sensor feedback data.

4. The agricultural implement system of claim 3, wherein the control assembly is configured to:
receive the sensor feedback data from the one or more sensors, wherein the one or more sensors comprise a pressure sensor configured to output the sensor feedback data indicative of a fluid pressure within the actuator;
determine whether the agricultural implement system is in the working position or the non-working position based on the sensor feedback data; and
control the actuator to operate the hitch assembly in the floating mode or the rigid mode based on the determined position of the agricultural implement system.

5. The agricultural implement system of claim 1, comprising a valve assembly having one or more valves configured to control a flow of fluid within the actuator of the hitch assembly, wherein the control assembly is communicatively coupled to the actuator via the valve assembly.

6. The agricultural implement system of claim 5, wherein the control assembly is configured to control the valve assembly to enable fluid to flow freely within the actuator while the hitch assembly is in the floating mode.

7. The agricultural implement system of claim 1, wherein the actuator is configured to block rotation of the hitch relative to a main frame of an implement of the agricultural implement system while the hitch assembly is in the rigid mode.

8. The agricultural implement system of claim 1, wherein the control assembly comprises a user interface configured to receive an operator input.

9. The agricultural implement system of claim 8, wherein the control assembly is configured to control the actuator based on the operator input.

10. The agricultural implement system of claim 1, wherein the control assembly is configured to control a center wheel actuator to move a center wheel relative to a main frame of an implement of the agricultural implement system to transition the agricultural implement system between the working and non-working positions.

11. The agricultural implement system of claim 10, wherein the control assembly is configured to control a stabilizer wheel actuator to move a stabilizer wheel relative to the main frame of the implement to transition the agricultural implement system between the working and non-working positions.

12. A method, comprising:
determining, via a control assembly, a position of an agricultural implement system, wherein the agricultural implement system comprises a hitch assembly having a hitch configured to couple the agricultural implement system to a work vehicle, the hitch assembly comprises an actuator configured to control the hitch, and the position of the agricultural implement system comprises a working position and a non-working position; and
controlling, via the control assembly, the actuator to operate the hitch assembly in a floating mode while the agricultural implement system is in the working position and to operate in a rigid mode while the agricultural implement system is in the non-working position.

13. The method of claim 12, wherein controlling the actuator comprises controlling a valve assembly fluidly coupled to the actuator.

14. The method of claim 13, wherein controlling the valve assembly comprises controlling the valve assembly to enable fluid to flow freely within the actuator while the hitch assembly is in the floating mode.

15. The method of claim 12, comprising receiving sensor feedback data from one or more sensors indicative of the position of the agricultural implement system.

16. The method of claim 12, comprising controlling, via the control assembly, a center wheel actuator to move a center wheel relative to a main frame of an implement of the agricultural implement system to transition the agricultural implement system between the working and non-working positions.

17. An agricultural implement system, comprising:
an agricultural implement having a main frame and a plurality of ground engaging tools coupled to the main frame;
a hitch assembly comprising:
a hitch configured to couple the agricultural implement system to a work vehicle; and
an actuating cylinder configured to control the hitch;
a valve assembly comprising one or more valves configured to control a flow of fluid within the actuating cylinder of the hitch assembly; and
a control assembly communicatively coupled to the valve assembly, wherein the control assembly comprises a memory configured to store instructions and one or more processors, wherein the control assembly is configured to control the valve assembly to control the actuating cylinder to operate the hitch assembly in a floating mode while the agricultural implement system is in a working position and to operate in a rigid mode while the agricultural implement system is in a non-working position.

18. The agricultural implement system of claim 17, comprising one or more sensors configured to output sensor feedback data, wherein the control assembly is configured to:
receive the sensor feedback data from the one or more sensors, wherein the one or more sensors comprise a pressure sensor configured to output the sensor feedback data indicative of a fluid pressure within the actuating cylinder;
determine whether the agricultural implement system is in the working position or the non-working position based on the sensor feedback data; and
control the valve assembly to control the actuating cylinder to operate the hitch assembly in the floating mode or the rigid mode based on the determined position of the agricultural implement system.

19. The agricultural implement system of claim 17, wherein the control assembly is configured to control the valve assembly to enable fluid to flow freely within the actuator while the hitch assembly is in the floating mode.

20. The agricultural implement system of claim 17, wherein the control assembly is configured to control a center wheel actuator to move a center wheel relative to the main frame of the implement to transition the agricultural implement system between the working and non-working positions.
